(19) United States
(12) Patent Application Publication
(10) Pub. No.: US 2026/0352605 A1
(43) Pub. Date: Nov. 5, 2026

(54) PDCP DISCARD INDICATIONS FOR XR

(71) Applicant: Apple Inc., Cupertino, CA (US)

(72) Inventors: Ralf Rossbach, Munich (DE); Ping-Heng Kuo, London (GB); Haijing Hu, Los Gatos, CA (US); Fangli Xu, Beijing (CN)

(21) Appl. No.: 19/124,517

(22) PCT Filed: Nov. 4, 2022
(86) PCT No.: PCT/CN2022/130003

§ 371 Date: Apr. 25, 2025

(51) Int. Cl. H04L 47/31; H04L 1/1607; H04L 47/34; H04W 28/06

(52) U.S. Cl. CPC H04L 47/31; H04L 1/1614; H04L 47/34; H04W 28/06

(57) ABSTRACT

Methods, systems, apparatuses, and computer programs for informing a packet data convergence protocol (PDCP) receiver of PDCP PDUs that are to be discarded. In one aspect, a method can include actions of determining, by a PDCP transmitter, a set of PDCP PDUs that are to be discarded, generating, by the PDCP transmitter, a discard marker in a PDCP PDU header that signals to a PDCP receiver that the determined plurality of PDCP PDUs are to be discarded, and transmitting, by the PDCP transmitter, the generated PDCP PDU to a PDCP receiver.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In XR operation, packet data convergence protocol (PDCP) operation includes a packet discard option where PDUs are discarded at a fairly regular basis such that packet discarding is no longer an abnormal event. In the conventional PDCP operation the discarding of a PDCP SDU already associated with a PDCP SN causes a SN gap in the transmitted PDCP Data PDUs, which increases PDCP reordering delay in the receiving PDCP entity. XR on the other hand requires low delay, and processing overhead and the use of system resources (including memory at the PDCP receiver) should be minimized.

Conventional systems have had PDCP transmitters that are plagued with the processing overhead of PDCP packet discarding causing an increase in the PDCP reordering delay at the PDCP receiver. However, the present disclosure provides systems and methods that can be employed to minimize the overhead of a PDCP receiver as a result of PDCP packet discarding at the PDCP transmitter by enhancing functionality of the PDCP receiver. In some instances, and as described in co-pending applications, a PDCP receiver can be employed to perform the operations of discarding PDCP PDU packets that the PDCP transmitters has marked for discarding, thus avoiding the overhead of the PDCP transmitter performing the process of discarding.

However, for a PDCP receiver to perform the process of discarding PDCP PDUs that have been tagged for discarding by the PDCP transmitter, the PDCP receiver has to be informed as to which particular PDCP PDUs have been marked for discarding by the PDCP transmitter and are still transmitted by the PDCP transmitter. The present disclosure provides multiple implementations for generating and transmitting, to a PDCP receiver, a discard marker (also referred to as a discard indicator) that informs a PDCP receiver of PDCP PDUs that are marked for discarding and can be discarded by the PDCP receiver.

Thus, the discard marker of the present disclosure enables functionality of a PDCP transmitter (e.g., PDCP PDU discarding of PDCP PDUs marked for discarding) to alleviate the PDCP receiver from performing reordering operations. In addition, the discarding of PDUs is a computationally intensive task as PDCP PDU discarding by a PDCP transmitter may occur after the PDCP PDU has been enciphered or after the PDCP PDU was transmitted to a lower level protocol.

In accordance with one innovative aspect of the present disclosure, a method for informing a packet data convergence protocol (PDCP) receiver of PDCP PDUs that are to be discarded, is disclosed. In one aspect the method can include actions of determining, by a PDCP transmitter, a set of PDCP PDUs that are to be discarded, generating, by the PDCP transmitter, a discard marker in a PDCP PDU header that signals to a PDCP receiver that the determined plurality of PDCP PDUs are to be discarded, and transmitting, by the PDCP transmitter, the generated PDCP PDU to a PDCP receiver.

Other aspects includes apparatuses, systems, and computer programs for performing the actions of the aforementioned method.

The innovative method can include other optional features. For example, in some implementations, the generated discard marker is in a PDCP PDU header of a first PDCP PDU by sequence number of the determined set of PDCP PDCP PDUs to be discarded. In such implementations, the discard marker is a one-bit indication indicating that (i) the first PDCP PDU and (ii) subsequent PDCP PDUs by sequence number in the set of PDCP PDUs are to be discarded by the PDCP receiver.

In some implementations, the generated discard marker is in a PDCP PDU header of a last nominal PDCP PDU by sequence number that is not to be discarded before a first PDCP PDU by sequence number of the determined set of PDCP PDUs that is to be discarded. In such implementations, the discard marker is a one-bit indication indicating that subsequent PDCP PDUs by sequence number in the set of PDCP PDUs are to be discarded by the PDCP receiver.

In some implementations, the method can further include for each particular PDCP PDU of the set of PDCP PDUs that are to be discarded: generating, by the PDCP transmitter, a one-bit discard marker in a PDCP PDU header of the particular PDCP PDU that signals to a PDCP receiver that the particular PDCP PDU is to be discarded.

In some implementations, the discard marker is a one-bit discard marker that signals to a PDCP receiver that (i) a PDCP PDU including the one-bit discard marker is to be discarded or (ii) a subsequent PDCP PDU by sequence number is to be discarded.

In some implementations, the discard marker indicates a PDCP PDU set identifier of the set of PDCP PDUs to be discarded.

In some implementations, the method can further include transmitting, by the PDCP transmitter, the set of PDCP PDUs that are to be discarded to the PDCP receiver.

In some implementations, the set of PDCP PDUs that are to be discarded have sequence numbers that are consecutively in sequence.

In some implementations, the generated discard marker is in a PDCP PDU header of a first PDCP PDU and signals to the PDCP receiver a first PDCP PDU by sequence number of the determined set of PDCP PDUs that are to be discarded. In such implementations, the method can further include generating, by the PDCP transmitter, a second discard marker in a last PDCP PDU of the determined set of PDCP PDUS that are to be discarded that signals to a PDCP receiver a last PDCP PDU by sequence number of the determined plurality of PDCP PDUs that are to be discarded.

In some implementations, the generated discard marker is in a PDCP PDU header of a first PDCP PDU and signals to the PDCP receiver a first PDCP PDU by sequence number of the determined set of PDCP PDUs that are to be discarded. In such implementations, the generated discard marker is in a PDCP PDU header of a last nominal PDCP PDU by sequence number that is not to be discarded before a first PDCP PDU by sequence number of the determined set of PDCP PDUs that is to be discarded and signals to the PDCP receiver that a subsequent PDCP PDU by sequence number is the first PDCP PDU of the determined set of PDCP PDUs that are to be discarded. In such implementations, the method can further include generating, by the PDCP transmitter, a second discard marker in a last PDCP PDU of the determined set of PDCP PDUS that are to be discarded that signals to a PDCP receiver a last PDCP PDU by sequence number of the determined plurality of PDCP PDUs that are to be discarded.

In some implementations, the generated discard marker is in a PDCP PDU header of a first PDCP PDU by sequence number of the determined set of PDCP PDUs to be discarded. In such implementations, the discard marker is a two-bit indication indicating that (i) a sequence number of a first PDCP PDU of the set of PDCP PDUs to be discarded and (ii) a sequence number of a last PDCP PDU of the set of PDCP PDUs to be discarded.

In some implementations, the discard marker is a two-bit indication indicating that (i) a sequence number of a first PDCP PDU of the set of PDCP PDUs to be discarded and (ii) a total number of subsequent PDCP PDUs that are to be discarded.

In some implementations, the PDCP PDU header is a header of a PDCP data PDU in the set of PDCP PDUs to be discarded.

In some implementations, the PDCP PDU header is a header of a PDCP PDU is sent in a padded PDCP data PDU that does not include other content.

In some implementations, the discard marker includes a parameter that singles to a PDCP receiver a number of discarded PDCP PDUs in flight.

According to another innovative aspect of the present disclosure, a method for informing a packet data convergence protocol (PDCP) receiver of PDCP PDUs that are to be discarded is disclosed. In one aspect, the method can include actions of determining, by a PDCP transmitter, a set of PDCP PDUs that are to be discarded, generating, by the PDCP transmitter, a PDCP control PDU that includes one or more parameters that signal to a PDCP receiver that the determined plurality of PDCP PDUs are to be discarded, and transmitting, by the PDCP transmitter, the generated PDCP control PDU to a PDCP receiver.

Other aspects includes apparatuses, systems, and computer programs for performing the actions of the aforementioned method.

The innovative method can include other optional features. For example, in some implementations, the method can further include transmitting, by the PDCP transmitter, the set of PDCP PDUs that are to be discarded to the PDCP receiver.

In some implementations, the PDCP control PDU includes a parameter indicating an identifier of a first PDCP PDU that is to be discarded. In such implementations, the identifier is a PDCP PDU sequence number.

In some implementations, the PDCP control PDU includes a plurality of parameters indicating (i) an identifier of a first PDCP PDU that is to be discarded and (ii) an identifier of a last PDCP PDU that is be discarded. In such implementations, the identifier of the first PDCP PDU that is to be discarded is a first PDCP PDU sequence number and the identifier for the last PDCP PDU that is to be discarded is a different PDCP PDU sequence number.

In some implementations, the PDCP control PDU includes a plurality of parameters indicating (i) a number of discarded PDCP PDUs in the PDCP PDU set to be discarded and (ii) an identifier of a reference PDCP PDU in the PDCP PDU set to be discarded. In such implementations, the identifier is a PDCP PDU sequence number and the reference PDCP PDU indicates (i) a PDCP PDU where discarding is to start or (ii) a PDCP PDU where the discarding is to stop.

In some implementations, the PDCP control PDU includes a plurality of parameters that signal multiple sets of PDCP PDU sets that are to be discarded. In such implementations, the plurality of parameters that signal multiple sets of PDCP PDU include multiple ranges of PDCP PDU sequence numbers corresponding to sequences of PDCP PDU sequences that are to be discarded.

In some implementations, the PDCP control PDU includes a parameter that indicates a PDCP PDU set identifier that identifies a PDCP PDU set that is to be discarded.

In some implementations, the PDCP control PDU includes a parameter indicating a number of PDCP PDUs to be discarded that are still in flight.

In some implementations, the method can further include generating, by the PDCP transmitter, a different PDCP control PDU indicating a number of PDCP PDUs to be discarded that are still in flight.

In some implementations, the PDCP control PDU is an extension of a PDCP status PDU.

In some implementations, the set of PDCP PDUs that is to be discarded has sequence numbers that are consecutively in sequence.

According to another innovative aspect of the present disclosure, a method for informing a packet data convergence protocol (PDCP) receiver of PDCP PDUs that are to be discarded is disclosed. In one aspect, the method can include actions of determining, by a PDCP transmitter, a set of PDCP PDUs that includes one or more PDCP PDUs that are to be discarded, generating, by the PDCP transmitter, a discard bitmap that signals to a PDCP receiver that the determined plurality of PDCP PDUs are to be discarded, wherein the discard bitmap includes a bitmap field for each PDCP PDU of a PDU set and has a toggled bit for each PDCP PDU of the PDCP PDU set that is to be discarded, and transmitting, by the PDCP transmitter, the generated discard bitmap to a PDCP receiver.

Other aspects includes apparatuses, systems, and computer programs for performing the actions of the aforementioned method.

The innovative method can include other optional features. For example, in some implementations, the determined set of PDCP PDUs that are to be discarded include PDCP PDUs having sequence numbers that are not consecutive.

In some implementations, the toggled bit for each PDCP PDU of the PDCP PDU set that is to be discarded is a bit that has been activated.

In some implementations, the toggled bit for each PDCP PDU of the PDCP PDU set that is to be discarded is a bit that has been deactivated.

In some implementations, the generated discard bitmap is transmitted to the PDCP receiver as a field of a PDCP status report PDU.

In some implementations, the generated discard bitmap is transmitted to the PDCP receiver as a field of a PDCP control PDU.

According to another innovative aspect of the present disclosure, a method for generating a discard bitmap report is disclosed. In one aspect, the method can include actions of determining, by a PDCP receiver, that a subset of essential PDCP PDUs has been received from a set of PDCP PDUs, generating, by the PDCP receiver, a PDCP status report that indicates, to the PDCP transmitter, that the PDCP transmitter can discard the remaining PDCP PDUs in the set of PDCP PDUs, and transmitting, by the PDCP receiver, the PDCP status report to the PDCP transmitter.

Other aspects includes apparatuses, systems, and computer programs for performing the actions of the aforementioned method.

The innovative method can include other optional features. For example, in some implementations, the PDCP status report comprises a discard bitmap that signals to the PDCP transmitter that the remaining PDCP PDUs in the set of PDCP PDs are to be discarded, wherein the discard bitmap includes a bitmap field for each PDCP PDU of the set of PDCP PDUs and has a toggled bit for each remaining PDCP PDU set that is to be discarded by the PDCP transmitter.

In some implementations, the remaining set of PDCP PDUs include PDCP PDUs having sequence numbers that are not consecutive.

In some implementations, the toggled bit for each remaining PDCP PDU of the PDCP PDU set that is to be discarded is a bit that has been activated.

In some implementations, the toggled bit for each remaining PDCP PDU of the PDCP PDU set that is to be discarded is a bit that has been deactivated.

According to another innovative aspect of the present disclosure, a method for generating a discard bitmap report is disclosed. In one aspect, the method can include actions of determining, by a PDCP receiver, a subset of PDCP PDUs of set of PDCP PDUs that have been locally discarded by the PDCP receiver, generating, by the PDCP receiver, a PDCP status report that indicates, to the PDCP transmitter, the subset of PDCP PDUs that have been locally discarded by the PDCP receiver, and transmitting, by the PDCP receiver, the PDCP status report to the PDCP transmitter.

Other aspects includes apparatuses, systems, and computer programs for performing the actions of the aforementioned method.

The innovative method can include other optional features. For example, in some implementations, the PDCP status report comprises a discard bitmap that signals to the PDCP transmitter that the subset of PDCP PDs have been locally discarded, wherein the discard bitmap includes a bitmap field for each PDCP PDU of the set of PDCP PDUs that have been locally discarded and has a toggled bit for each PDCP PDU that were locally discarded by the PDCP receiver.

In some implementations, the subset of PDCP PDUs that have been locally discarded by the PDCP receiver include PDCP PDUs having sequence numbers that are not consecutive.

In some implementations, the toggled bit for each PDCP PDU that was locally discarded by the PDCP receiver is a bit that has been activated.

In some implementations, the toggled bit for each remaining PDCP PDU that was locally discarded by the PDCP receiver is a bit that has been deactivated.

According to another innovative aspect of the present disclosure, a method for implicit determination of PDCP PDU packets marked for discarding is disclosed. In one aspect, the method can include actions of detecting, by a PDCP receiver, that a first PDCP PDU Set signals a last sequence number earlier than expected, detecting, by the PDCP receiver, that a next PDU set signals a first sequence number, and determining, by the PDCP receiver, that the PDCP PDUs having a sequence number between the last sequence number of the first PDCP PDU set and the first sequence number of the next PDU set are to be discarded.

Other aspects includes apparatuses, systems, and computer programs for performing the actions of the aforementioned method.

According to another innovative aspect of the present disclosure, a method for implicit indication of PDCP PDU packets for discarding is disclosed. In one aspect, the method can include actions of determining, by a PDCP transmitter, that remaining PDCP PDUs in a PDU set are to be discarded; and setting, by the PDCP transmitter, a last sequence number in the PDCP PDU set to the last actual PDCP PDU that is to be processed.

Other aspects includes apparatuses, systems, and computer programs for performing the actions of the aforementioned method.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a wireless network, according to some implementations.

FIG. 2 is a flowchart of a process for informing a PDCP receiver of a set of PDCP PDUs that are to be discarded using a discard marker in a PDCP data PDU header.

FIG. 3 illustrates an example of a PDCP control PDU format for a PDCP discard status report.

FIG. 4 is a flowchart of a process for informing a PDCP receiver of a set of PDCP PDUs that are to be discarded using a discard marker in a PDCP control PDU.

FIG. 5 is a flowchart of a process for informing a PDCP receiver of a set of PDCP PDUs that are to be discarded using a PDCP discard bitmap.

FIG. 5A illustrates a description of fields of a discard bitmap.

FIG. 6 is a flowchart of a process of a PDCP receiver informing a PDCP transmitter that remaining PDCP PDUs in a set of PDCP PDUs can be discarded after processing of essential PDCP PDUs from the set of PDCP PDUs.

FIG. 7 is a flowchart of a process of a PDCP receiver informing a PDCP transmitter that a subset of PDCP PDUs of set of PDCP have been locally discarded by the PDCP receiver.

FIG. 8 illustrates a description of fields of a discard bitmap report.

FIG. 9 illustrations an example of another PDCP control PDU format for a PDCP discard status report.

FIG. 10 illustrates a user equipment (UE), according to some implementations.

FIG. 11 illustrates an access node, according to some implementations.

### DETAILED DESCRIPTION

The present disclosure provides multiple implementations for generating and transmitting, to a PDCP receiver, a discard marker (also referred to as a discard indicator) that informs a PDCP receiver of PDCP PDUs that are marked for discarding and can be discarded by the PDCP receiver.

Thus, the discard marker of the present disclosure enables functionality of a PDCP transmitter (e.g., PDCP PDU discarding of PDCP PDUs marked for discarding) to alleviate the PDCP receiver from performing reordering operations. In addition, the discarding of PDUs is a computationally intensive task as PDCP PDU discarding by a PDCP transmitter may occur after the PDCP PDU has been enciphered or after the PDCP PDU was transmitted to a lower level protocol.

Other implementations provided by the present disclosure enable a PDCP receiver to generate and transmit discard feedback reports to a PDCP transmitter. Such discard feedback reports can inform the PDCP transmitter of PDCP PDUs that can be discarded or have been locally discarded by the PDCP receiver, thus alleviating additional overhead processing by the PDCP transmitter related to these to be discarded or locally discarded PDCP PDUs.

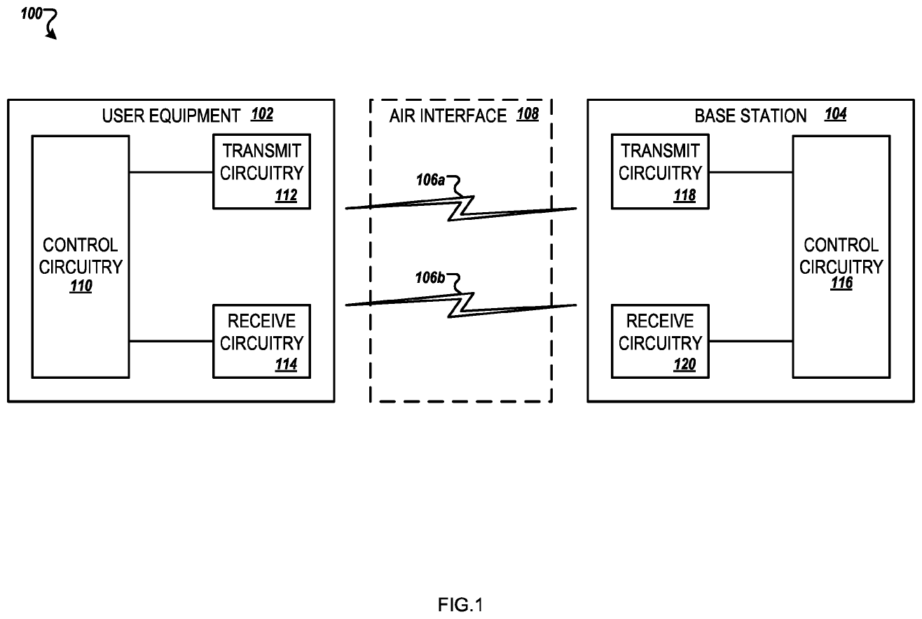

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

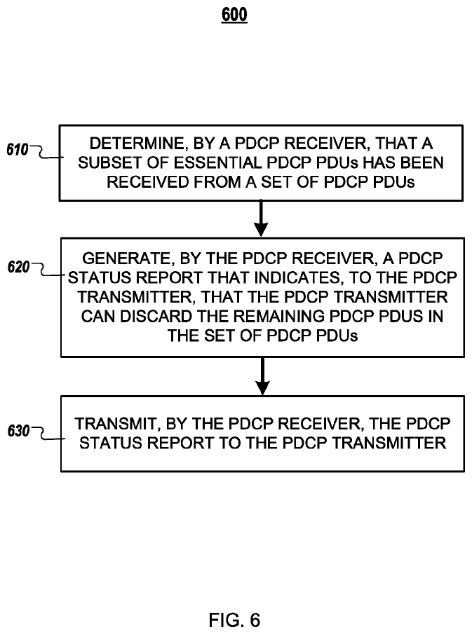

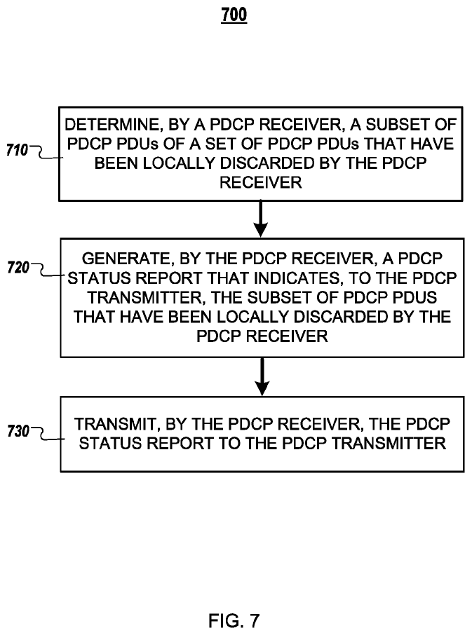

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE. By way of example, when the UE 102 is a PDCP receiver the control circuitry 110 can perform operations related to determining that all essential PDUs of a PDU set have been processed and generate a discard bitmap report that provides an indication to a PDCP transmitter of the remaining PDCP PDUS of the PDU set that can be discarded. These operations can include, for example, one or more operations 610, 620 of FIG. 6. Likewise, when the UE 102 is a PDCP receiver, the control circuitry 110 can perform operations related to determining a set of PDCP PDUs that have been locally discarded by the PDCP receiver and generate a discard feedback report that indicates to a PDCP transmitter the PDCP PDUs that have been locally discarded by the PDCP receiver. These operations can include, for example, operations 710, 720 of FIG. 7.

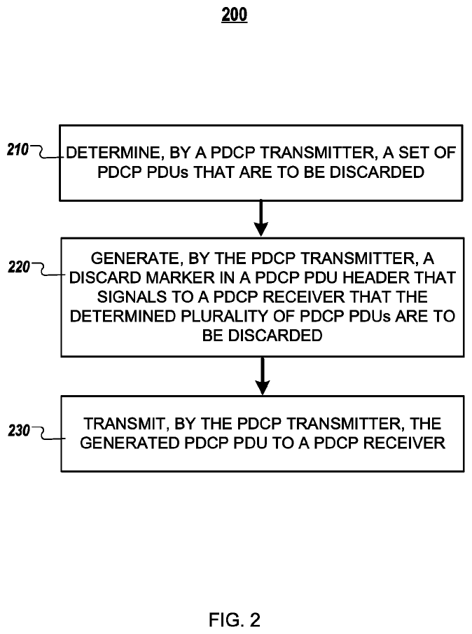

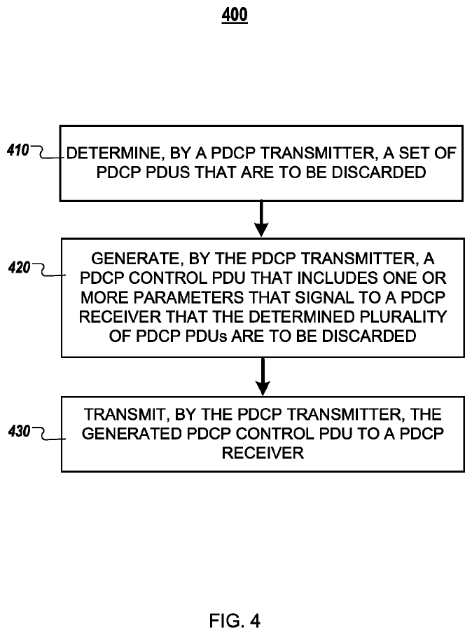

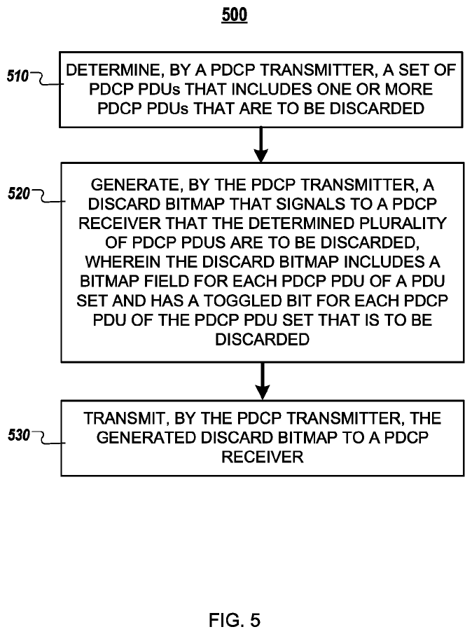

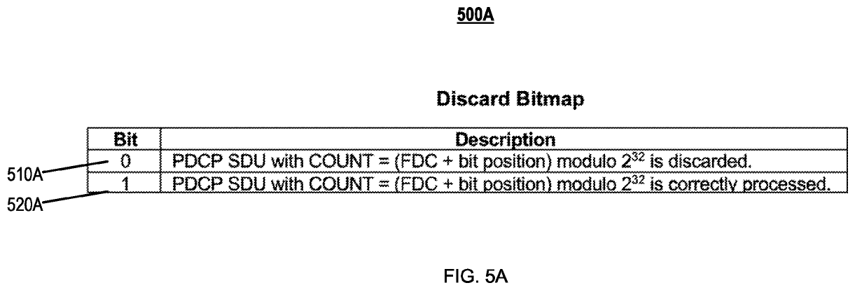

By way of a different example, when the UE 102 is a PDCP transmitter, the control circuitry 110 can perform operations of FIGS. 2, 210, 220 that determine a set of PDCP PDUs that are to be discarded and generate a discard marker in PDCP header that signals to a PDCP receiver that the determined plurality of PDCP PDUs are to be discarded. Likewise, when a PDCP transmitter, the control circuitry 110 of the UE 102 can perform operations 410, 420 of FIG. 4 by determining a set of PDCP PDUs that are to be discarded and generating a PDCP control PDU that includes one or more parameters that signal to a PDCP receiver that the determined plurality of PDCP PDUs are to be discarded. Likewise, when a PDCP transmitter, the control circuitry 110 can also perform the operations 510, 520 of FIG. 5 that determine a set of PDCP PDUs that include one or more PDCP PDUs that are to be discarded and generate a discard bitmap that signals to a PDCP receiver that the determined plurality of PDCP PDUs are to be discarded.

The transmit circuitry 112 can perform various operations described in this specification. For example, when the UE is a PDCP transmitter the transmit circuitry 112 can, for example, transmit a generated PDCP data PDU including a discard marker to a PDCP receiver, transmit the generated PDCP control PDU to a PDCP receiver, or transmit a generated discard bitmap to a PDCP receiver as recited in operations 230, 430, and 530 of FIGS. 2, 4, and 5, respectively. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, when the UE 102 is a PDCP receiver, the UE 102 can use the receive circuitry 114 to receive discard markers transmitted by a PDCP transmitter. Likewise, when a UE 102 is PDCP transmitter, the UE 102 can use the receive circuitry 114 to receive discard bitmap reports and discard feedback reports from a PDCP receiver. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. In addition, for example, when the base station 104 is a PDCP transmitter, the base station can use the transmit circuitry 118 to, for example, perform the operations attributed to a PDCP transmitter recited in operations 230 of FIGS. 2, 430 of FIG. 4, and 530 of FIG. 5. Alternatively, when the base station is a PDCP receiver, the base station 104 can use the transmit circuitry 118, e.g., to perform operations attributed to a PDCP receiver in FIGS. 6, 630 and FIGS. 7, 730. The base station 104 may use receive circuitry 120 to receive a plurality of uplink physical channels from various UEs, including the UE 102. In addition, when the base station 104 is the PDCP receiver, the base station 104 can receive discard markers sent from a PDCP transmitter. In addition, when the base station 104 is a PDCP transmitter, the base station 104 can use the receive circuitry to 120 to receive discard bitmap reports and discard feedback reports transmitted by a PDCP receiver using operations 630 of FIGS. 6 and 730 of FIG. 7, respectively. In addition, the when the base station 104 is a PDCP receiver, the base station 104 can use the control circuitry 116 to perform operations 610, 620 of FIGS. 6 and 710, 720 of FIG. 7. Likewise, when the base station 104 is a PDCP transmitter, the base station 104 can use the control circuitry 116 to perform operations of 210, 220 of FIGS. 2, 410, 420 of FIG. 4, and 510, 520 of FIG. 5.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

### Discard Marker For Dynamic Signaling of Discarded PDCP PDUs

In some implementations, where PDUs in a PDU Set are consecutive and a discard condition triggers at a specific SN within a sequence of PDUs in the PDU Set, the remaining PDUs in the PDU set (which are assumed to be consecutive) can be understood as slated for discard. That has been, for example, one of the options and in line with current assumptions by SA2 and RAN2.

In some implementations, a PDCP transmitter can indicate a discard indication, referred to herein as a discard marker, to the PDCP receiver. In some implementations, the discard marker is associated with the sequence number (SN) of a PDU to be discarded (e.g., the first PDU in a sequence). In some implementations, the discard marker can be a one-bit indicator.

In some implementations, the discard marker can be signaled, for example, using one of the Reserved bits (R-bits) in a Data PDU header. Since a Data PDU is typically associated with a SN anyway, the receiver can identify the PDU(s) intended to be discarded. In implementations when a Data PDU cannot be not used a separate SN may be included (e.g., in a Control PDU) along with the discard marker.

The discard indication can either serve as a discard command from the transmitter to the receiver or as an indication of PDUs that have been discarded at the transmitter. As a result, the receiver can minimize the reordering delay or utilize this awareness to further optimize the processing.

### Scenario Where PDCP Receiver is Aware of Remaining PDUs in PDU Set

In some implementations, when the PDCP receiver is aware of the number of remaining PDUs in the PDU Set (or they can be derived by the receiver, e.g., based on PDU Set size or another description or indication provided for the PDU Set), the discard marker can be implemented in a number of different ways.

In some implementations, for example, the transmitter can signal a one-bit indication on the first PDU to be discarded or on the last actual PDU to be transmitted in the PDU Set. Then, subsequent PDUs in the PDU Set are meant to be discarded as well.

In some implementations, a one-bit discard marker can be given for one or multiple PDUs in the PDU Set. For example, when the first PDU to be discarded is associated with, e.g., SN=555 (and say, the last nominal SN in the PDU Set is at SN=750), the discard marker may be sent on either, e.g., SN=555 (the first PDU to be discarded) or on, e.g., SN=554 (the last actual PDU in the PDU Set).

In some implementations, a one-bit discard marker can be repeated several times e.g. to avoid loss of the discard information. For example, the discard marker could be set on, e.g., SN=554, 555, 556, or at a later time.

### Scenario Where PDCP Receiver is Aware of Remaining PDUs in PDU Set

In some implementations, when the PDCP receiver is not aware of the number of remaining PDUs in the PDU Set the transmitter may send an additional discard marker using the SN of the last nominal PDU in the PDU Set. This can be implemented in a number of different ways For example, in some implementations, there can be at least two discard markers, one on, e.g., SN=554 (or SN=555) for the first SN to be discarded, and one on, e.g., SN=750 for the last SN to be discarded in the PDU Set. The two SNs (e.g., 555 and 750) could be sent immediately after, e.g., SN=554.

In other implementations, two bits (e.g. 2 adjacent reserved bits in a PDU header) may be used to encode a first and a last discard marker, associated with, e.g., a first and a last SN to be discarded

Alternatively or additionally, the transmitter may indicate “the number of PDCP PDUs to be discarded together” (for consecutive PDUs). So, if, e.g., SN=555 is to be discarded, the transmitter further indicates, e.g., “195” so anything between 555 and 555+195 (=750 ) should be discarded.

Since actual application layer data is to be discarded the discard marker (when given on a PDU SN meant to be discarded) the discard marker may be sent on an otherwise empty PDU (with small padding or dummy data, or with zero content). Alternatively, the discard marker can be given on a Control PDU.

In some implementations, some form of dynamic (in-band) signaling may be available in a PDU header where the last SN in a PDU Set can be identified. Thus, when the remaining PDUs in a PDU Set are to be discarded, the transmitter can simply set that last SN indication earlier, e.g., already on the last actual SN in the PDU Set (e.g. SN=554). This referred, e.g., as an implicit discard indication or early termination of the PDU Set.

In some implementations, when the next SN (e.g. SN=555) already carries the first PDU of the next PDU Set, an explicit discard marker may not be required and the reordering delay is minimized naturally.

For example, when the nominal number of PDUs in the PDU Set is known to the receiver in advance (e.g., from semi-static signaling or through an indication in a PDU Set descriptor (P55803), or when a general PDU Set description is signaled at the start of the PDU Set, the last PDU in the PDU Set can be indicated earlier than expected, using the normal end-of-PDU set signaling already on the last actual SN. For example, the number of nominal PDUs in the PDU Set is indicated as, e.g., 500 PDUs but the transmitter already signals the end of the PDU Set after, e.g., 260 PDUs. When the nominal number of PDUs in the PDU Set is not known upfront, the same method may be used. In addition, the normal start-of-PDU set signalling of the next PDU Set may be used to identify the next SN. By using the parameters in the packet header that describe the PDU Set, both the last SN before the gap and the first SN after the gap can be identified, assuming that PDU Set 1 (with an end-of-PDU set signalling) is succeeded by PDU Set 2 (with a start-of-PDU set signalling).

The above option depends on the final split between semi-static and dynamic (in-band) parameters that will be available for the PDU Set. In some instances, an immediate termination of a PDU Set may be challenging to UE/gNB implementation as it would mean that PDCP PDUs already submitted to lower layers (e.g., SN=555, 556, . . . 590) would have to be discarded in lower layers queues before the same PDCP SNs can be associated with a different PDU Set. Therefore, a discard marker (or another form of discard signaling) may be considered. For example, using a discard marker the PDU Set can be terminated at, e.g., SN=554. In order to account for PDUs already submitted to lower layers, the next PDU Set could start immediately on the next SN (e.g., SN=591 in the example above)—or whatever is the number of PDUs already submitted to lower layers.

In another option, the transmitter may inform the receiver of packets that are expired (e.g., identified as to be discarded) but which it will continue to transmit, e.g., by indicating the PDUs already submitted to lower layers due to the constrains above. This may be done in a separate discard marker (with a new combination of R-bits when two R-bits are used), in a separate PDCP Control PDU, or by extending a PDCP Data/Control PDU with a parameter to indicate those special packets, or even in a new RLC Control PDU (as the number of packets is available at RLC) or in a MAC CE.

The number of packets submitted to lower layers may be implementation-specific (pre-processing) or may depend on the discard timing. Therefore, the transmitter may decide this number. Alternatively, there could be a configuration (from the NW for a UE, or an operator config, for a gNB) to configure a fixed value or such expired PDUs. In this case a separate signalling is not necessarily required.

### Discard Marker Signaled Using PDCP Data PDU Header

In some implementations, a discard marker can be implemented in a PDCP Data PDU header. PDCP Data PDU header options to signal a Discard Marker can be implemented in either uplink (UL) or in downlink (DL)).

In some implementations, R-bits are available for all types of Data PDUs, 1 or 2 R-bits may be used to signal a discard marker in a PDCP Data PDU header.

In some implementations, use 1 or 2 R-bits to signal a discard marker, plus an extra parameter to indicate the number of discarded PDUs (e.g., the “195” in the example above). This option may be useful when, e.g., PDUs are already submitted to lower layers (pre-processing) or when the nominal number of PDUs in the PDU set is unknown to the PDCP receiver.

In some implementations, if the PDCP receiver knows the “PDU Set Identifier”, the PDCP transmitter can just indicate the identifiers of PDU Sets that should be discarded all together (if applicable). So, 1 or 2 R-bits can be used to signal a discard marker, plus an extra parameter to signal one or more PDU Set Identifiers. In some implementations, this option can be combined with the implementation above that uses an extra parameter to indicate the number of discarded PDUs.

In some implementations, 2 R-bits may be used for the discard marker, where one R-bit combination is used to indicate a preconfigured number of PDUs meant to be discarded but which are still in-flight. Other than the 2-bit combination indicating the discard marker type no other parameter is needed.

In some implementations, the options above combined with an extra parameter to indicate the number of discarded PDUs that are in flight.

FIG. 2 is a flowchart of a process 200 for informing a PDCP receiver of a set of PDCP PDUs that are to be discarded using a discard marker in a PDCP data PDU header. The process 200 will be described herein as being performed by a PDCP transmitter that transmits a PDCP discard marker. For purposes of the present disclosure, a PDCP receiver can be a UE or base station that receives PDCP PDUs. Likewise, a PDCP transmitter can be a UE or base station that transmits a PDCP PDUs. Thus, communication between a PDCP transmitter and a PDCP receiver can be between a UE to base station communication, base station to UE communication, or UE to UE communication.

A PDCP transmitter can begin execution of the process 200 by determining a set of PDCP PDUs that are to be discarded (210).

A PDCP transmitter can continue execution of the process 200 by generating a discard marker in a PDCP PDU header that signals to a PDCP receiver that the determined plurality of PDCP PDUs are to be discarded (220).

A PDCP transmitter can continue execution of the process 200 by transmitting the generated PDCP PDU to a PDCP receiver (230).

In some implementations, the generated discard marker is in a PDCP PDU header of a first PDCP PDU by sequence number of the determined set of PDCP PDUs to be discarded. In such implementations, the discard marker is a one-bit indication indicating that (i) the first PDCP PDU and (ii) subsequent PDCP PDUs by sequence number in the set of PDCP PDUs are to be discarded by the PDCP receiver.

In some implementations, the generated discard marker is in a PDCP PDU header of a last nominal PDCP PDU by sequence number that is not to be discarded before a first PDCP PDU by sequence number of the determined set of PDCP PDUs that is to be discarded. In such implementations, the discard marker is a one-bit indication indicating that subsequent PDCP PDUs by sequence number in the set of PDCP PDUs are to be discarded by the PDCP receiver.

In some implementations, for each particular PDCP PDU of the set of PDCP PDUs that are to be discarded, the PDCP transmitter can continue execution of the process 200 by generating a one-bit discard marker in a PDCP PDU header of the particular PDCP PDU that signals to a PDCP receiver that the particular PDCP PDU is to be discarded.

In some implementations, the discard marker is a one-bit discard marker that signals to a PDCP receiver that (i) a PDCP PDU including the one-bit discard marker is to be discarded or (ii) a subsequent PDCP PDU by sequence number is to be discarded.

In some implementations, the discard marker indicates a PDCP PDU set identifier of the set of PDCP PDUs to be discarded. In some implementations, the set of PDCP PDUs that are to be discarded have sequence numbers that are consecutively in sequence.

In some implementations, the PDCP transmitter can continue execution of the process 200 by transmitting the set of PDCP PDUs that are to be discarded to the PDCP receiver.

In some implementations, the generated discard marker is in a PDCP PDU header of a first PDCP PDU and signals to the PDCP receiver a first PDCP PDU by sequence number of the determined set of PDCP PDUs that are to be discarded. In such implementations, the PCDP transmitter can continue execution of the process 200 by generating a second discard marker in a last PDCP PDU of the determined set of PDCP PDUS that are to be discarded that signals to a PDCP receiver a last PDCP PDU by sequence number of the determined plurality of PDCP PDUs that are to be discarded.

In some implementations, the generated discard marker is in a PDCP PDU header of a first PDCP PDU and signals to the PDCP receiver a first PDCP PDU by sequence number of the determined set of PDCP PDUs that are to be discarded. In such implementations, the generated discard marker is in a PDCP PDU header of a last nominal PDCP PDU by sequence number that is not to be discarded before a first PDCP PDU by sequence number of the determined set of PDCP PDUs that is to be discarded and signals to the PDCP receiver that a subsequent PDCP PDU by sequence number is the first PDCP PDU of the determined set of PDCP PDUs that are to be discarded. In such implementations, the PDCP transmitter can continue execution of the process 200 by generating a second discard marker in a last PDCP PDU of the determined set of PDCP PDUS that are to be discarded that signals to a PDCP receiver a last PDCP PDU by sequence number of the determined plurality of PDCP PDUs that are to be discarded.

In some implementations, the generated discard marker is in a PDCP PDU header of a first PDCP PDU by sequence number of the determined set of PDCP PDUs to be discarded. In such implementations, the discard marker is a two-bit indication indicating that (i) a sequence number of a first PDCP PDU of the set of PDCP PDUs to be discarded and (ii) a sequence number of a last PDCP PDU of the set of PDCP PDUs to be discarded.

In some implementations, the discard marker is a two-bit indication indicating that (i) a sequence number of a first PDCP PDU of the set of PDCP PDUs to be discarded and (ii) a total number of subsequent PDCP PDUs that are to be discarded.

In some implementations the PDCP PDU header is a header of a PDCP data PDU in the set of PDCP PDUs to be discarded.

In some implementations, the PDCP PDU header is a header of a PDCP PDU is sent in a padded PDCP data PDU that does not include other content.

Ins some implementations, the discard marker includes a parameter that singles to a PDCP receiver a number of discarded PDCP PDUs in flight.

### New PDCP Control PDU Options for Signaling Discard Marker

In some implementations, a discard marker can be implemented in a PDCP Control PDU. The PDCP Control PDU can be used to signal a discard marker in either uplink (UL) or in downlink (DL).

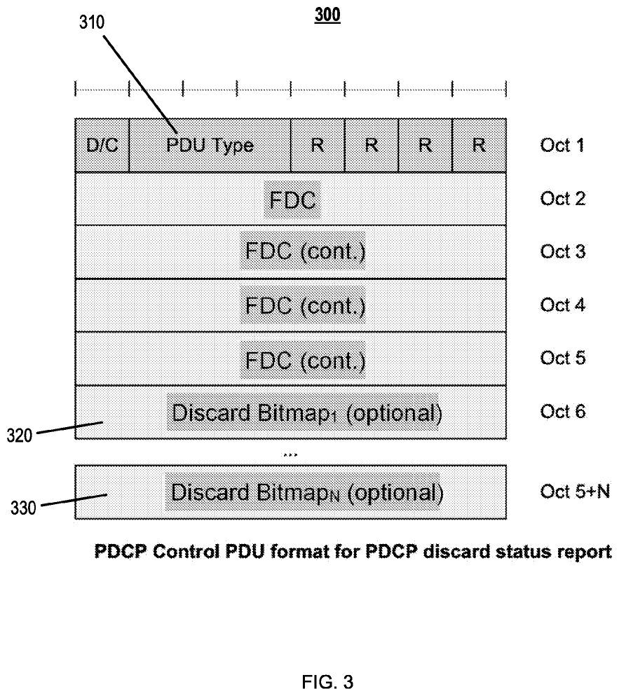

In some implementations, a new control PDU is provided for use as a discard marker Control PDU (or PDCP Discard Status Report). An example of the new discard marker control PDU 300 is illustrated in FIG. 3. The discard marker control PDU 300 can include fields indicating data necessary to provide a PDCP discard report status for discard operation. In some implementations, the PDU Type 310 at Oct. 1 can be new PDU type indicating that the PDCP Control PDU 300 is used as a discard marker. Fields at Oct 2-5 may be used for indicating a first discard sequence number or count (FDC) of one or more ranges of PDCP sequence numbers. Optionally, the new discard marker control PDU 300 can be extended to include optional fields 320, 330, if the new discard marker control PDU 300 is used to report a discard bitmap as described with respect to, for example, 5, 6, and 7.

The new discard marker Control PDU can include a number of different parameter options. These parameter options are not mutually exclusive and can be combined.

In some implementations, only one parameter is included in the discard marker Control PDU. In such implementations, the one parameter can indicate, for example, a COUNT/SN of the first PDU to be discarded.

In some implementations, two parameters can be included in the discard marker Control PDU. In some implementations, the two parameters can include, for example, a) COUNT or SN of the first PDU to be discarded; b) COUNT/SN of the last PDU to be discarded. In other implementations, the two parameters can include, for example, a) number of discarded PDUs in the PDU set; b) Reference SN/COUNT (to indicate the start or stop of the discarding).

In some implementations, a variable format with multiple sets of discarded SNs/COUNT where each SN set in itself is in-sequence, but multiple blocks of SNs/COUNTs can be indicated. This implementation can be based on any of the implementations described above related to the new discard marker Control PDU.

In some implementations, any option above/below related to the new discard marker Control PDU can be combined with a parameter to indicate one (or more) PDU Set Identifier(s).

In some implementations, a separate discard marker Control PDU can be used to indicate a preconfigured number of PDUs meant to be discarded which are still in-flight.

In some implementations, any option above for the discard marker Control PDU can be combined with an extra parameter to indicate the number of discarded PDUs in flight.

In some implementations, an extension of the existing an PDCP Status PDU (e.g., using one of the implementations above) can be used for the new discard marker Control PDU.

In some implementations, the discard marker Control PDU can be used when PDUs are discarded consecutively, or partly consecutively (in multiple blocks). As a principle, the PDCP receiver considers the last PDU before discard and the next PDU after discard as in-sequence. Upon reception of the discard marker signaling the PDCP receiver may as well eliminate the SN gap using one of the methods in solution 2 or 3. The PDCP receiver can use the new parameters to update its reordering window. If needed, the PDCP receiver may also use the information to update its (existing) PDCP status variables accordingly.

FIG. 4 is a flowchart of a process 400 for informing a PDCP receiver of a set of PDCP PDUs that are to be discarded using a discard marker in a PDCP control PDU. The process 400 will be described herein as being performed by a PDCP transmitter that transmits a PDCP discard marker. For purposes of the present disclosure, a PDCP receiver can be a UE or base station that receives PDCP PDUs. Likewise, a PDCP transmitter can be a UE or base station that transmits a PDCP PDUs. Thus, communication between a PDCP transmitter and a PDCP receiver can be between a UE to base station communication, base station to UE communication, or UE to UE communication.

A PDCP transmitter can being execution of the process 400 by determining a set of PDCP PDUs that are to be discarded (410).

The PDCP transmitter can continue execution of the process 400 by generating a PDCP control PDU that includes one or more parameters that signal to a PDCP receiver that the determined plurality of PDCP PDUs are to be discarded (420).

The PDCP transmitter can continue execution of the process 400 by transmitting the generated PDCP control PDU to a PDCP receiver (430).

In some implementations, the PDCP transmitter can continue execution of the process 400 by transmitting the set of PDCP PDUs that are to be discarded to the PDCP receiver.

In some implementations, the PDCP control PDU can include a parameter indicating an identifier of a first PDCP PDU that is to be discarded. In such implementations, the identifier is a PDCP PDU sequence number.

In some implementations, the PDCP control PDU can include a plurality of parameters indicating (i) an identifier of a first PDCP PDU that is to be discarded and (ii) an identifier of a last PDCP PDU that is be discarded. In such implementations, the identifier of the first PDCP PDU that is to be discarded is a first PDCP PDU sequence number and the identifier for the last PDCP PDU that is to be discarded is a different PDCP PDU sequence number.

In some implementations, the PDCP control PDU can include a plurality of parameters indicating (i) a number of discarded PDCP PDUs in the PDCP PDU set to be discarded and (ii) an identifier of a reference PDCP PDU in the PDCP PDU set to be discarded. In such implementations, the identifier is a PDCP PDU sequence number and the reference PDCP PDU indicates (i) a PDCP PDU where discarding is to start or (ii) a PDCP PDU where the discarding is to stop.

In some implementations, the PDCP control PDU can include a plurality of parameters that signal multiple sets of PDCP PDU sets that are to be discarded.

In some implementations, the plurality of parameters that signal multiple sets of PDCP PDU can include multiple ranges of PDCP PDU sequence numbers corresponding to sequences of PDCP PDU sequences that are to be discarded.

In some implementations, he PDCP control PDCU can include a parameter that indicates a PDCP PDU set identifier that identifies a PDCP PDU set that is to be discarded.

In some implementations, the PDCP control PDU can include a parameter indicating a number of PDCP PDUs to be discarded that are still in flight.

In some implementations, the PDCP transmitter can continue execution of the process 400 by generating a different PDCP control PDU indicating a number of PDCP PDUs to be discarded that are still in flight.

In some implementations, PDCP control PDU is an extension of a PDCP status PDU.

In some implementations, the set of PDCP PDUs that is to be discarded has sequence numbers that are consecutively in sequence.

### PDCP Discard Bitmap

There could be a mode where a PDU Set can be considered complete when a defined or configured amount (or percentage) of PDUs in a PDU Set is confirmed to be successfully sent on lower layers (e.g., HARQ ACKed). Once all such “essential” PDUs/SNs have been received the transmitter could inform the receiver using a PDCP status report (or PDCP discard report). The status report informs the receiver of PDUs that are intended to be discarded at the transmitter. The receiver can use this information to minimize the reordering delay.

Moreover, the triggers for such discarding of PDUs are specific to XR, where multiple conditions can lead to a discard of a PDU Set or a part of the PDU Set.

However, in the aforementioned instances, not all the to be discarded PDUs may be in-sequence. To identify such ‘scattered’ PDUs/SNs, a discard bitmap can be provided in a PDCP status report/PDCP discard report. The discard bitmap has a format similar the existing bitmap in the PDCP status report but it uses a bitmap field for setting (or nor setting) a bit for e.g. every PDU that has been discarded. An example of such a discard bitmap is shown in FIG. 5A.

In some implementations, use of the discard marker in a PDCP Data PDU Header or a new PDCP Control PDU may not be optimal or applicable to minimize the reordering delay when discarded PDUs are not in-sequence. Instead, the PDCP receiver can store the discard bitmap and selectively skip those discarded PDUs as part of the reordering process (by not introducing a waiting time and by considering every last PDU before a discard and every next PDU after a discard as in-sequence). Such behavior is somewhat more complex. A PDCP receiver can handle this based on implementation, but a protocol may still need to define the bitmap and have the procedure text indicate that the receiver uses the discard bitmap to minimize reordering delay.

A discard bitmap such as the discard bitmap 500A of FIG. 5A can be used by the PDCP transmitter to inform the PDCP receiver of multiple discarded PDUs (including the case where the discarded PDUs are not always in-sequence). The Discard Bitmap can be a new field in a PDCP Status Report such as, for example, in one or more optional fields 320, 330 of PDCP Control PDU 300. Alternatively, a separate PDCP Status Report (or Control PDU) used for discard reporting.

In FIG. 3, the PDCP Control PDU can have one or more first discard count (FDC) fields of PDCP status report. In some implementations, each of the one or more FDC fields can have a length of 32 bits. Each FDC field can indicate the COUNT value of SN of the first discarded PDCP SDU of a PDU Set at the PDCP transmitter.

Each discard bitmap such as discard bitmap 500A of FIG. 5A can have a variable length. In some implementations, the length of the discard bitmap field can be 0.

Each field in the discard bitmap 500A indicates which SDUs are discarded and which SDUs are correctly transmitted/processed in the transmitting PDCP entity. The bit position of N^{th} bit in the Discard Bitmap is N, i.e., the bit position of the first bit in the Bitmap is 1. In some implementations, a bit corresponding to a PDCP PDU can be set or activated if the bit is toggled to a value of ‘1’. Otherwise, the bit corresponding to a PDCP PDU can be not set or deactivated if the bit is toggled to a value of ‘0’.

FIG. 5 is a flowchart of a process 500 for informing a PDCP receiver of a set of PDCP PDUs that are to be discarded using a PDCP discard bitmap. The process 500 will be described herein as being performed by a PDCP transmitter that transmits a PDCP discard marker. For purposes of the present disclosure, a PDCP receiver can be a UE or base station that receives PDCP PDUs. Likewise, a PDCP transmitter can be a UE or base station that transmits a PDCP PDUs. Thus, communication between a PDCP transmitter and a PDCP receiver can be between a UE to base station communication, base station to UE communication, or UE to UE communication.

A PDCP transmitter can begin execution of the process 500 by determining a set of PDCP PDUs that includes one or more PDCP PDUs that are to be discarded (510).

The PDCP transmitter can continue execution of the process 500 by generating a discard bitmap that signals to a PDCP receiver that the determined plurality of PDCP PDUs are to be discarded, wherein the discard bitmap includes a bitmap field for each PDCP PDU of a PDU set and has a toggled bit for each PDCP PDU of the PDCP PDU set that is to be discarded (520).

The PDCP transmitter can continue execution of the process 500 by transmitting the generated discard bitmap to a PDCP receiver (530).

In some implementations, the determined set of PDCP PDUs that are to be discarded include PDCP PDUs having sequence numbers that are not consecutive.

In some implementations, the toggled bit for each PDCP PDU of the PDCP PDU set that is to be discarded is a bit that has been activated.

In some implementations, the toggled bit for each PDCP PDU of the PDCP PDU set that is to be discarded is a bit that has been deactivated.

In some implementations, the generated discard bitmap is transmitted to the PDCP receiver as a field of a PDCP status report PDU.

In some implementations, the generated discard bitmap is transmitted to the PDCP receiver as a field of a PDCP control PDU.

### PDCP Discard Bitmap Report By PDCP Receiver After Processing Essential PDCP PDUs

In some implementations, there could be a mode where a PDU Set can be considered complete when a defined or configured amount (or percentage) of PDUs in a PDU Set is received. Once all such “essential” PDUs/SNs have been received the receiver could inform the transmitter using a PDCP status report/PDCP discard report. The status report informs the receiver of PDUs that are intended to be discarded at the transmitter. Thereafter, the PDCP transmitter may discard the remaining PDUs in the PDU set. Note that not all the to be discarded PDUs may be in-sequence. In order to identify such ‘scattered’ PDUs a bitmap could be provided in a PDCP status report. In other words, this function could simply reply on the existing status report for an acknowledgement. Such status report is triggered once all “essential” SNs have been received. Alternatively, a new PDCP discard status report could be used

However, note that not all the to be discarded PDUs may be in-sequence. In order to identify such ‘scattered’ PDUs a bitmap could be provided in a PDCP status report such as PDCP Control PDU 900. In other words, this function could simply reply on the existing status report for an acknowledgement. Such status report is triggered once all “essential” SNs have been received. Alternatively, a new PDCP discard status report could be used.

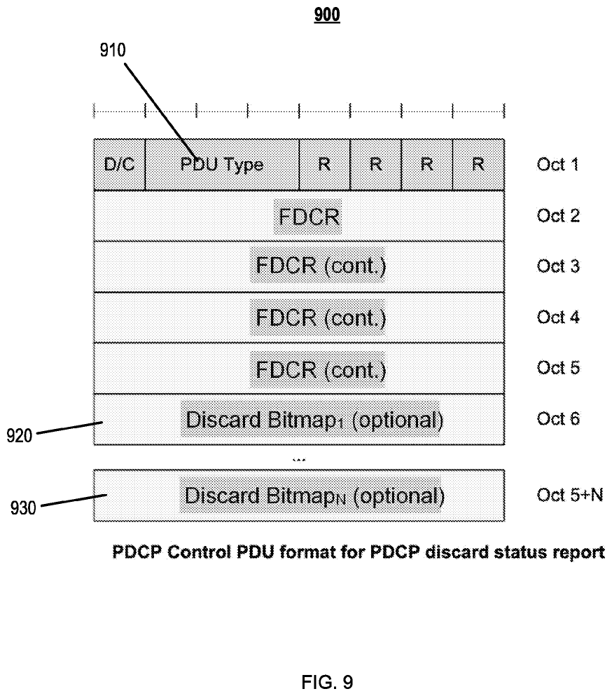

In more detail, another example of a new discard marker control PDU 900 is illustrated in FIG. 9. The discard marker control PDU 900 can include fields indicating data necessary to provide a PDCP discard report status for discard operation. In some implementations, the PDU Type 910 at Oct. 1 can be new PDU type indicating that a new PDCP Control PDU 900 is used as a discard marker. Fields at Oct 2-5 may be used for a count or SN of the first discarded PDCP PDU within the reordering window at the PDCP receiver. Optionally, the new discard marker control PDU 900 can be extended to include optional fields 920, 930, if the new discard marker control PDU 900 is used to report a discard bitmap as described with respect to, for example, FIG. 6 or 7.

In FIG. 9, the PDCP control PDU 900 can have one or more first discard count reports (FDCR). In some implementations, the FDCR field has a length of 32 bits. The FDCR field can indicate the count value of the first discarded PDCP SDU within the reordering window at the receiver.

Each discard bitmap report 800 can have a variable length. In some implementations, the length of the discard bitmap field can be 0.

Each field in the discard bitmap report 800 indicates which SDUs are discarded and which SDUs are correctly received/processed in the receiving PDCP entity. The bit position of the Nth bit in the discard bitmap report 800 is N, i.e., the bit position of the first bit in the discard bitmap report is 1.

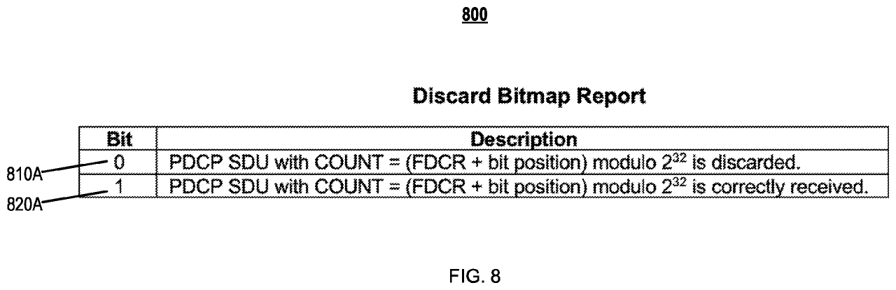

In some implementations, a discard bitmap report such as discard bitmap report 800 of FIG. 8 could be used by the PDCP receiver to inform the PDCP transmitter of multiple discarded PDUs (including the case where the discarded PDUs are not always in-sequence). The discard bitmap report 800 can be a new field in a PDCP Status Report such as, for example, in one or more optional fields 920, 930 of PDCP Control PDU 900. Alternatively, a separate PDCP Status Report (or Control PDU) used for discard reporting.

FIG. 6 is a flowchart of a process 600 of a PDCP receiver informing a PDCP transmitter that remaining PDCP PDUs in a set of PDCP PDUs can be discarded after processing of essential PDCP PDUs from the set of PDCP PDUs. The process 600 will be described herein as being performed by a PDCP receiver that transmits a discard bitmap report. For purposes of the present disclosure, a PDCP receiver can be a UE or base station that receives PDCP PDUs. Likewise, a PDCP transmitter can be a UE or base station that transmits a PDCP PDUs.

A PDCP receiver can begin execution of the process 600 by determining that a subset of essential PDCP PDUs has been received from a set of PDCP PDUs (610).

The PDCP receiver can continue execution of the process 600 by generating a PDCP status report that indicates, to the PDCP transmitter, that the PDCP transmitter can discard the remaining PDCP PDUs in the set of PDCP PDUs (620).

The PDCP receiver can continue execution of the process 600 by transmitting the PDCP status report to the PDCP transmitter (630).

In some implementations, the PDCP status report can include a discard bitmap that signals to the PDCP transmitter that the remaining PDCP PDUs in the set of PDCP PDs are to be discarded, wherein the discard bitmap includes a bitmap field for each PDCP PDU of the set of PDCP PDUs and has a toggled bit for each remaining PDCP PDU set that is to be discarded by the PDCP transmitter.

In some implementations, the remaining set of PDCP PDUs include PDCP PDUs having sequence numbers that are not consecutive.

In some implementations, the toggled bit for each remaining PDCP PDU of the PDCP PDU set that is to be discarded is a bit that has been activated.

In some implementations, the toggled bit for each remaining PDCP PDU of the PDCP PDU set that is to be discarded is a bit that has been deactivated.

### PDCP Discard Feedback Report by PDCP Receiver Reporting Locally Discarded PDCP PDUs

In some implementations, if the PDCP receiver needs to inform the PDCP transmitter of any PDUs that have been discarded locally at the PDCP receiver, the PDCP receiver can send a feedback report to the PDCP transmitter.

For example, a PDCP receiver may generate and transmit such a discard feedback report to provide feedback as a result of special discard rules the receiver is configured with or even applies dynamically. By way of another example, a PDCP receiver may generate and provide such a discard feedback report after reordering involving PDU discard. Alternatively, or in addition, the PDCP receiver may generate and transmit a discard feedback report when other layers (or the PDCP layer itself) request the discard of a complete PDU Set or the discarding of the remaining PDUs in a PDU Set.

In some implementations, it is assumed that to be discarded PDUs may not be in-sequence to identify such ‘scattered’ PDUs/SNs, a discard bitmap could be provided in a PDCP status report/PDCP discard report. In some implementations, the discard bitmap has a format similar the existing bitmap in the PDCP status report but it uses a bitmap field for setting (or nor setting) a bit for e.g. every PDU that has been discarded. An example of a bitmap report that can be used for the discard feedback report is shown in FIG. 8 and an example of a PDCP control PDU that can be used to transmit the bitmap feedback report is shown in FIG. 9.

FIG. 7 is a flowchart of a process 700 of a PDCP receiver informing a PDCP transmitter that a subset of PDCP PDUs of set of PDCP have been locally discarded by the PDCP receiver. The process 700 will be described herein as being performed by a PDCP receiver that transmits a discard feedback report. For purposes of the present disclosure, a PDCP receiver can be a UE or base station that receives PDCP PDUs. Likewise, a PDCP transmitter can be a UE or base station that transmits a PDCP PDUs.

A PDCP receiver can begin execution of the process 700 by determining a subset of PDCP PDUs of set of PDCP PDUs that have been locally discarded by the PDCP receiver (710).

The PDCP receiver can continue execution of the process 700 by generating a PDCP status report that indicates, to the PDCP transmitter, the subset of PDCP PDUs that have been locally discarded by the PDCP receiver (720).

The PDCP receiver can continue execution of the process 700 by transmitting the PDCP status report to the PDCP transmitter (730).

In some implementations, the PDCP status report can include a discard bitmap that signals to the PDCP transmitter that the subset of PDCP PDs have been locally discarded, wherein the discard bitmap includes a bitmap field for each PDCP PDU of the set of PDCP PDUs that have been locally discarded and has a toggled bit for each PDCP PDU that were locally discarded by the PDCP receiver.

In some implementations, the subset of PDCP PDUs that have been locally discarded by the PDCP receiver include PDCP PDUs having sequence numbers that are not consecutive.

In some implementations, the toggled bit for each PDCP PDU that was locally discarded by the PDCP receiver is a bit that has been activated.

In some implementations, the toggled bit for each remaining PDCP PDU that was locally discarded by the PDCP receiver is a bit that has been deactivated.

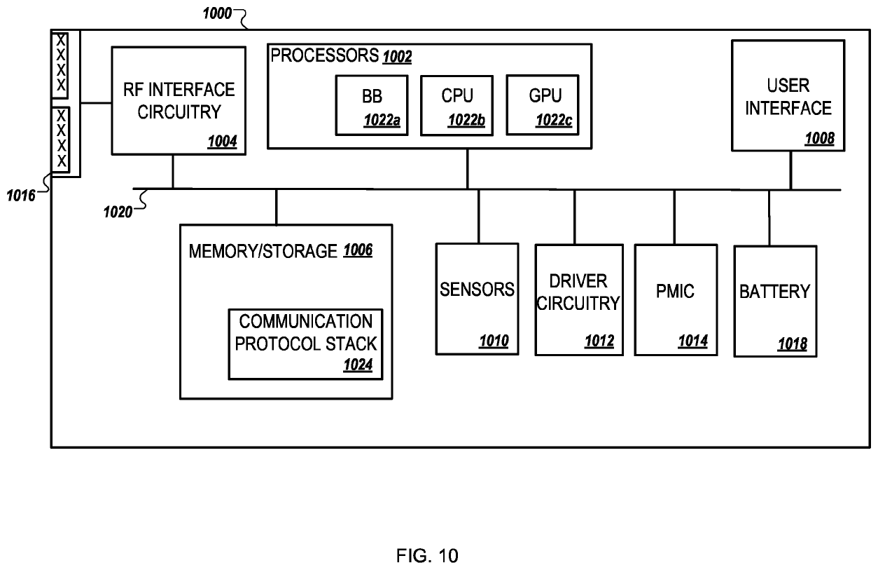

FIG. 10 illustrates a UE 1000, according to some implementations. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, antenna structure 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1016. In various implementations, the RF interface circuitry 1004 may be configured to transmit/receive signals in a manner compatible with NR access technologies.

The antenna 1016 may include antenna elements to convert electrical signals into radio waves to travel through the air and to convert received radio waves into electrical signals. The antenna elements may be arranged into one or more antenna panels. The antenna 1016 may have antenna panels that are omnidirectional, directional, or a combination thereof to enable beamforming and multiple input, multiple output communications. The antenna 1016 may include microstrip antennas, printed antennas fabricated on the surface of one or more printed circuit boards, patch antennas, phased array antennas, etc. The antenna 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensor circuitry 1010 and control and allow access to sensor circuitry 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

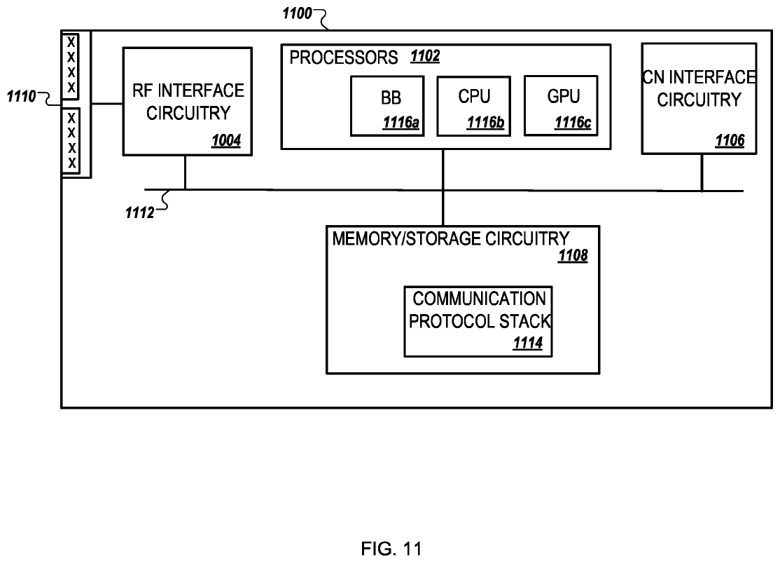

FIG. 11 illustrates an access node 1100 (e.g., a base station or gNB), according to some implementations. The access node 1100 may be similar to and substantially interchangeable with base station 104. The access node 1100 may include processors 1102, RF interface circuitry 1104, core network (CN) interface circuitry 1106, memory/storage circuitry 1108, and antenna structure 1110.

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112(f) interpretation for that component.

### OTHER EMBODIMENTS

Particular embodiments of the present disclosure have been described. Other embodiments are within the scope of the following claims. For example, the steps recited in the claims or any processes described herein combined, performed in a different order, or both, and still achieve desirable results.

1-20. (canceled)

21. One or more processors configured to, when executing instructions stored in a memory, perform operations comprising:
generating, in response to detection of a trigger condition, a packet data convergence protocol (PDCP) status report comprising a discard marker based at least on (i) a number of discarded PDCP data units associated with the PDCP status report and (ii) a count value associated with each of the discarded PDCP data units; and
submitting the PDCP status report to lower layers for transmission.

22. The one or more processors of claim 21, wherein the discard marker in the PDCP status report comprises a first discarded count (FDC) field indicating a smallest count value among the discarded PDCP data units associated with the PDCP status report.

23. The one or more processors of claim 22, wherein the FDC field has a length of 32 bits.

24. The one or more processors of claim 21, wherein generating the PDCP status report comprises including a discard bitmap in the PDCP status report when more than one PDCP data unit is discarded.

25. The one or more processors of claim 24, wherein the discard bitmap has a variable length.

26. The one or more processors of claim 24, wherein a length of the discard bitmap corresponds to the number of discarded PDCP data units associated with the PDCP status report.

27. The one or more processors of claim 24, wherein a length of the discard bitmap can be 0.

28. The one or more processors of claim 24, wherein the discard bitmap indicates which PDCP data units are discarded and which PDCP data units are not discarded by a transmitting PDCP entity.

29. The one or more processors of claim 24, wherein the discard bitmap comprises a respective bit value of 1 for each discarded PDCP data unit associated with the PDCP status report.

30. The one or more processors of claim 21, the operations further comprising instructing radio frequency (RF) circuitry to transmit a PDCP Control Protocol Data Unit (PDU) comprising the PDCP status report.

31. The one or more processors of claim 21, wherein detecting the trigger condition comprises determining that (i) there is at least one stored PDCP data unit with a count value larger than the discarded PDCP data units and (ii) the discarded PDCP data units have not been submitted to lower layers.

32. A method comprising:
generating, in response to detection of a trigger condition, a PDCP status report comprising a discard marker based at least on (i) a number of discarded PDCP data units associated with the PDCP status report and (ii) a count value associated with each of the discarded PDCP data units; and
submitting the PDCP status report to lower layers for transmission.

33. The method of claim 32, wherein the discard marker in the PDCP status report comprises an FDC field indicating a smallest count value among the discarded PDCP data units associated with the PDCP status report.

34. The method of claim 33, wherein the FDC field has a length of 32 bits.

35. The method of claim 32, wherein generating the PDCP status report comprises including a discard bitmap in the PDCP status report when more than one PDCP data unit is discarded.

36. The method of claim 35, wherein the discard bitmap has a variable length.

37. The method of claim 35, wherein a length of the discard bitmap corresponds to the number of discarded PDCP data units associated with the PDCP status report.

38. The method of claim 35, wherein a length of the discard bitmap can be 0.

39. The method of claim 35, wherein the discard bitmap indicates which PDCP data units are discarded and which PDCP data units are not discarded by a transmitting PDCP entity.

40. An apparatus comprising one or more processors configured to perform operations comprising:
generating, in response to detection of a trigger condition, a PDCP status report comprising a discard marker based at least on (i) a number of discarded PDCP data units associated with the PDCP status report and (ii) a count value associated with each of the discarded PDCP data units; and
submitting the PDCP status report to lower layers for transmission.
